(19) United States
(12) Patent Application Publication
(10) Pub. No.: US 2016/0274549 A1
(43) Pub. Date: Sep. 22, 2016

(54) Silicone Necklace Holder For Apple Watch

(71) Applicant: Antonio G. Rasmus, Elmont, NY (US)

(72) Inventor: Antonio G. Rasmus, Elmont, NY (US)

(21) Appl. No.: 14/660,826

(22) Filed: Mar. 17, 2015

(51) Int. Cl. G04G 21/00; G04B 37/00; G04B 37/14; A44C 15/00

(52) U.S. Cl. CPC G04G 21/00; A44C 15/005; G04B 37/0008; G04B 37/1446

(57) ABSTRACT

The abstract is the connecting devise that slides into the watch and at the same time converts the AppleWatch into a hanging device. The device can be anything in the form of jewelry. A slide in devise that's connected to a single holding port that supports a custom changeable chain. The device also is connected to a double port holder that can be attach to our custom chain that spins around. Each of these devises can be use for a chain in which it can be used for a necklace or a pocket watch or any other hanging device.

### SUMMARY OF THE INVENTION

Disclosed herein is a necklace for supporting an Apple® Watch through a custom connector inserted into the strap slot on an Apple® Watch. The silicone connector snaps into place on the watch and accepts a necklace, advantageously silicone, to support the watch from the user's neck.

Alternatively, a regular watch can be supported by a custom necklace connector slipped over the strap pin.

### DESCRIPTION OF DRAWINGS

FIG. 1 shows a male connector element 10 slipping into the female strap groove 11 on an Apple® Watch. Decorative elements 12 may be inserted into the other female strap groove;

FIG. 2 shows silicone necklace cords 13 attaching to the connector elements 10;

FIG. 3 shows silicone necklace cords 13 connecting to silicone sleeves 15 which slide over conventional watch pins 16 to support a conventional watch from the neck; decorative sleeves 16 are mounted on the other watch pin;

FIG. 4 shows an alternative silicone male connector element 16 and necklace cords 17 with lower decorative elements 18 for an Apple® Watch;

FIG. 5 shows an alternative necklace attachment for an Apple® Watch;

FIG. 6 shows alternative male necklace connectors and decorative elements for Apple® Watches and regular watches;

FIG. 7 shows alternative male necklace connectors and decorative elements for Apple® Watches and regular watches.

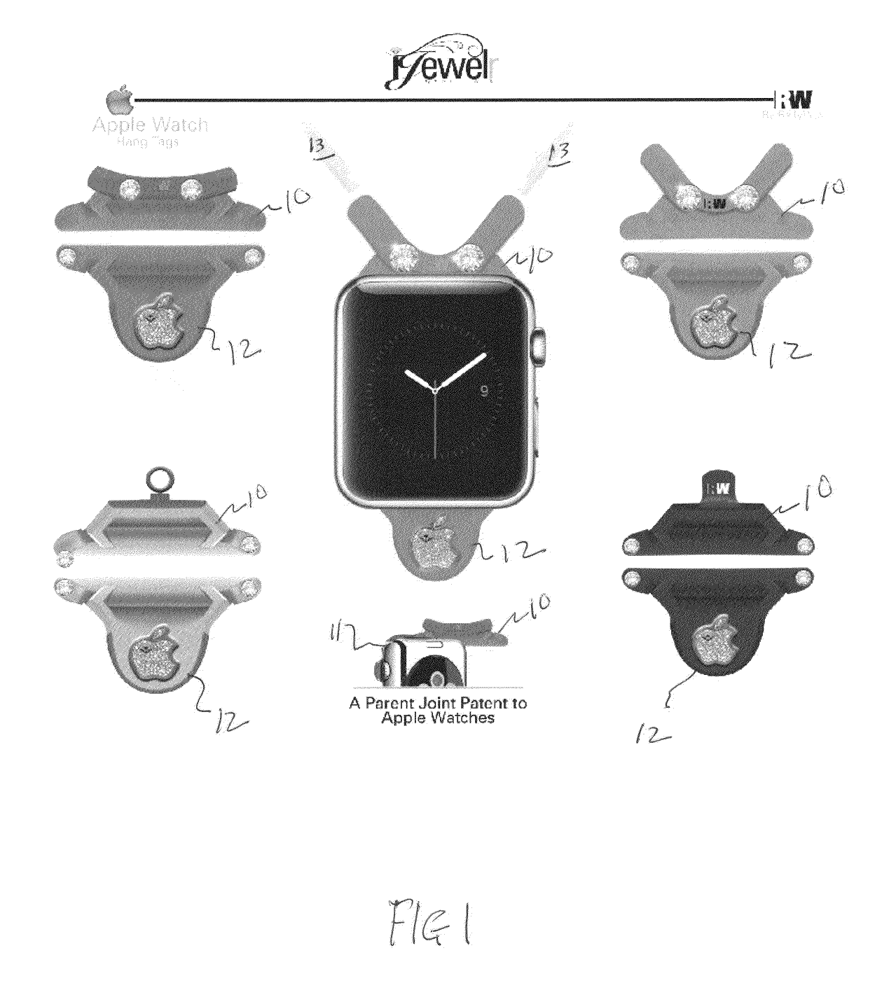

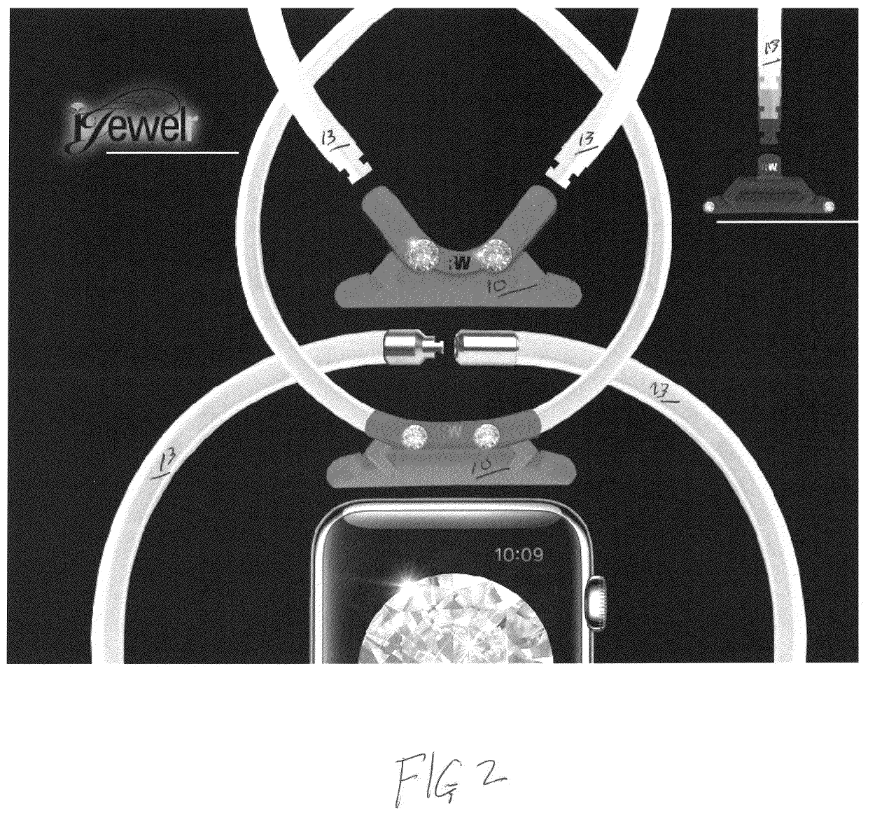

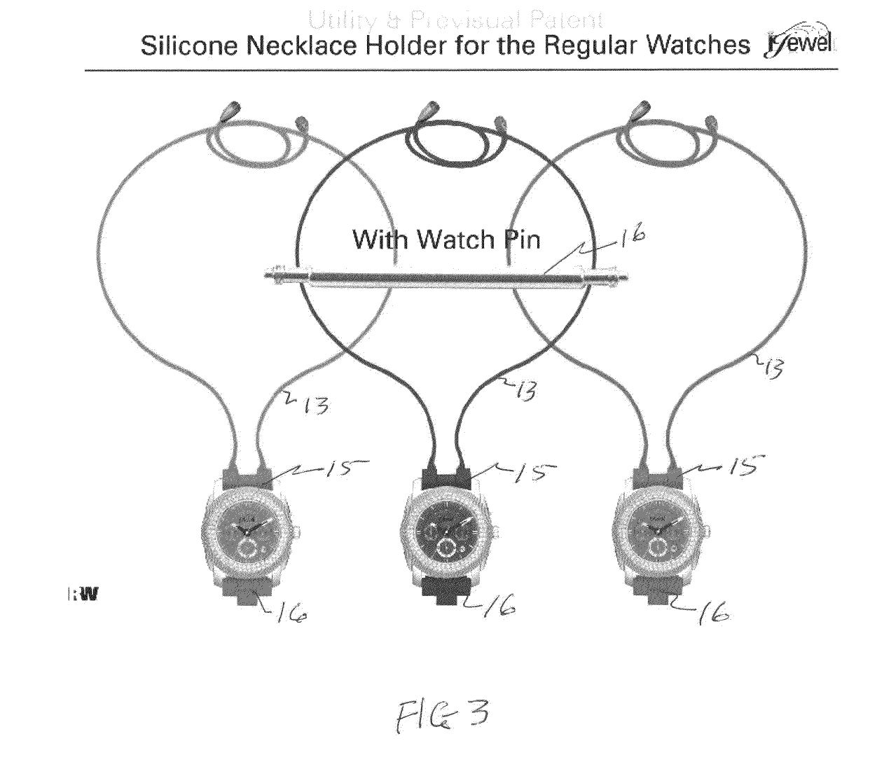

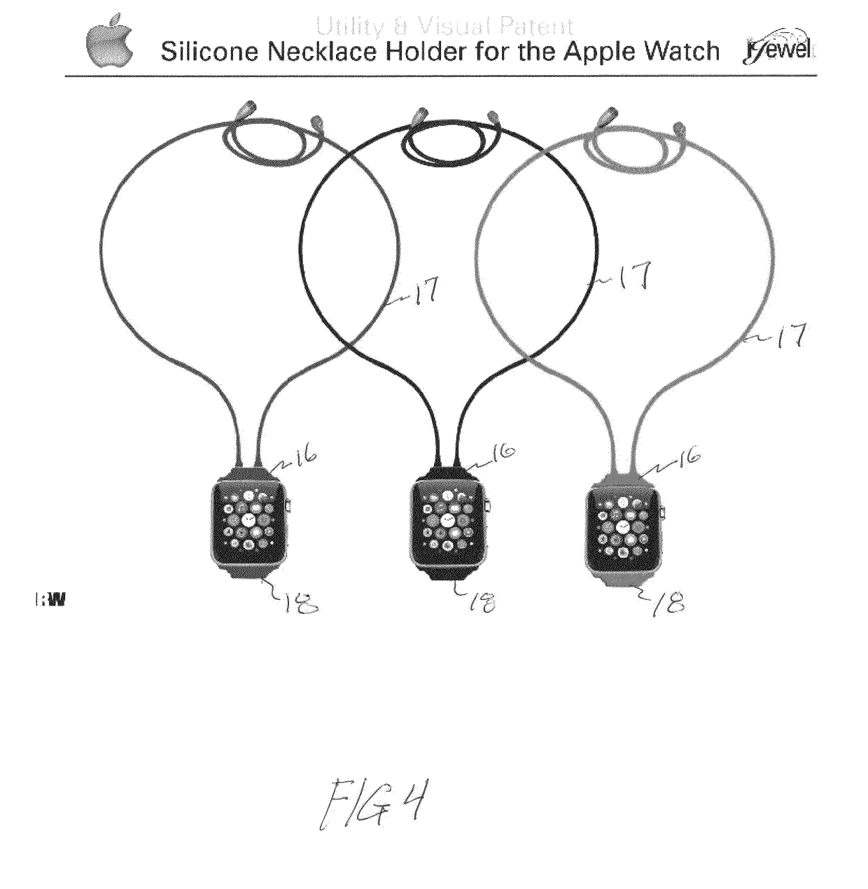

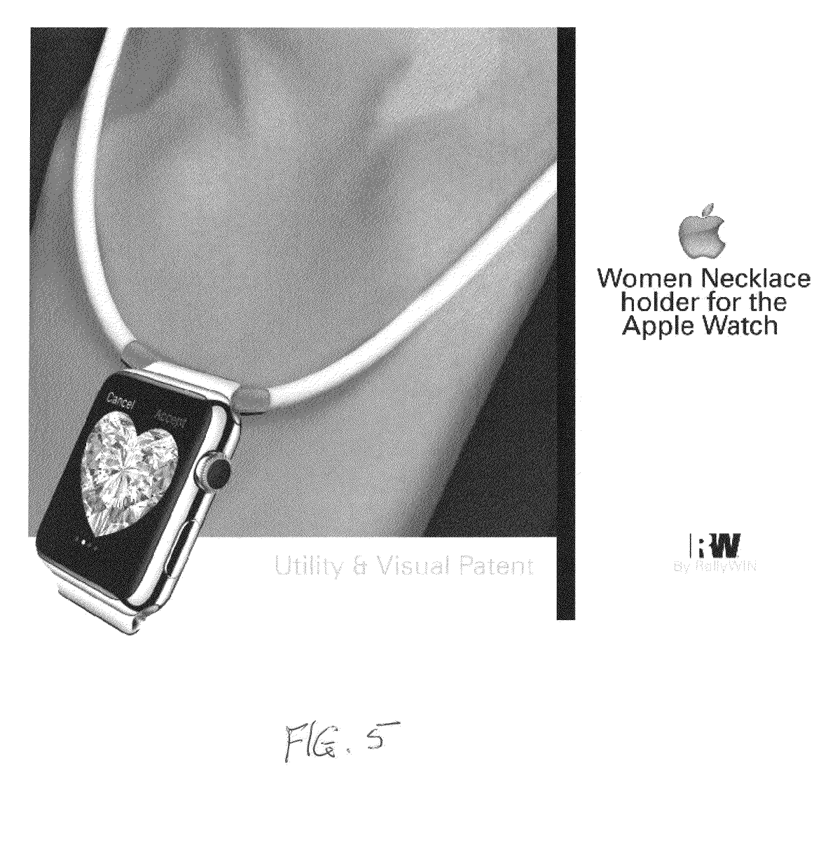

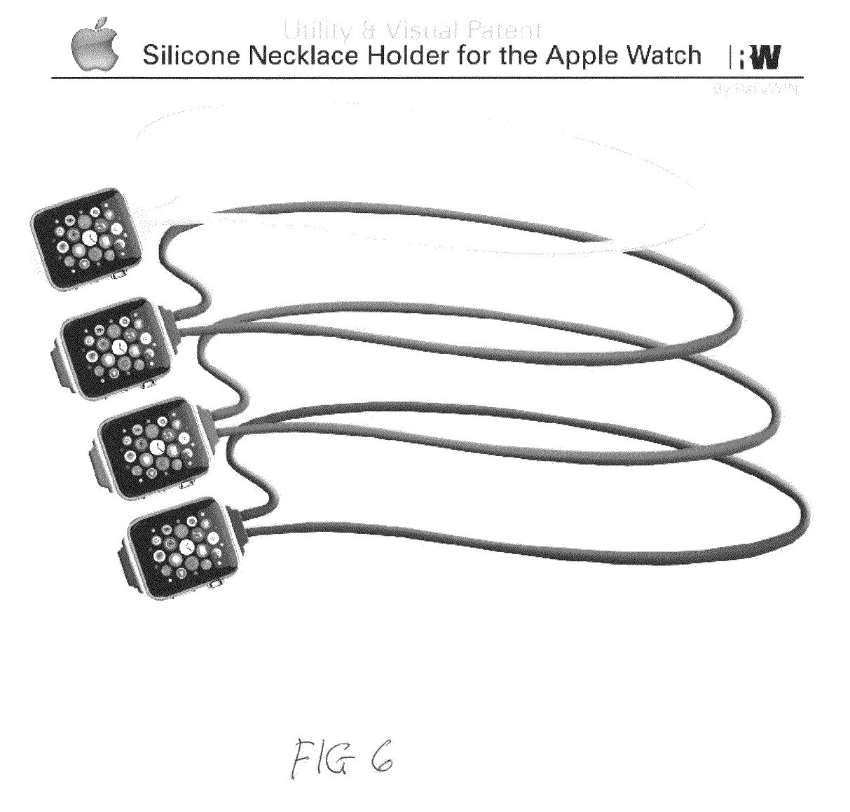

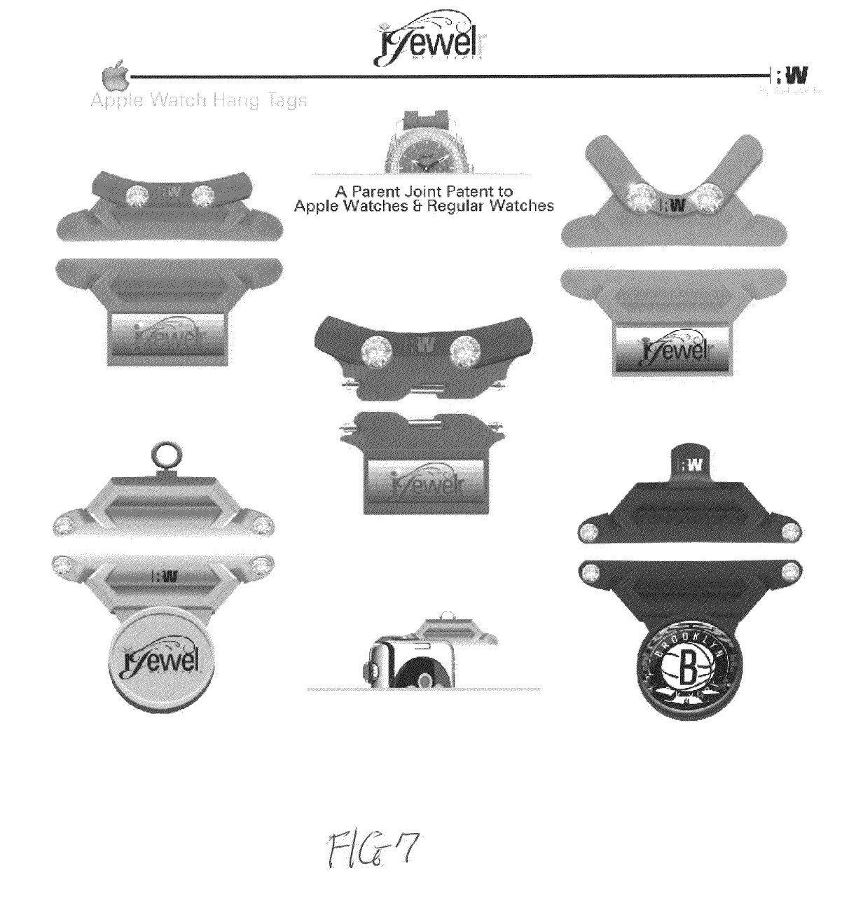

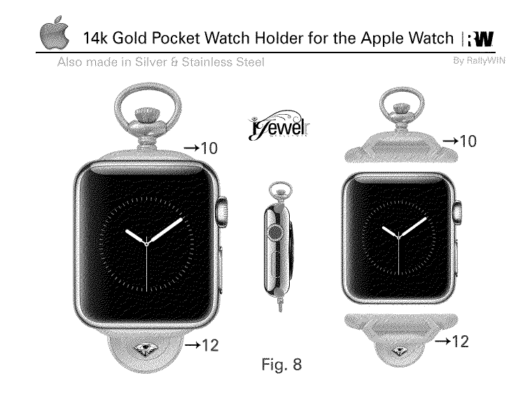

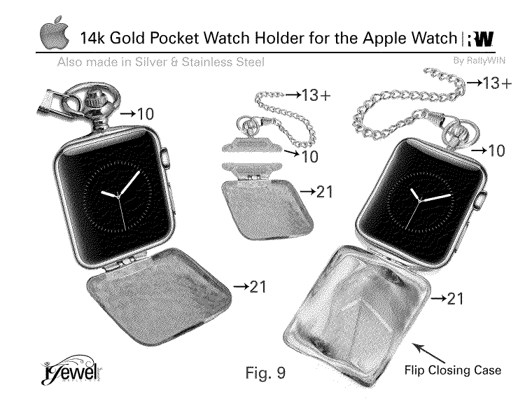

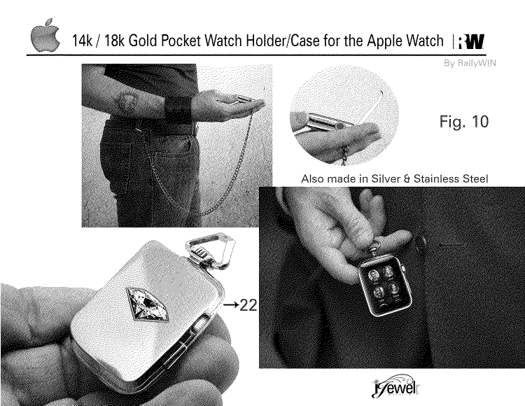

### SUMMARY OF THE INVENTION

Disclosed herein is a pocket watch for supporting Apple® Watch through a custom connector inserted into the slot on an Apple® Watch. The Gold, Silver, Stainless Steel or Plastic snaps into place on the watch accepts a POCKET WATCH. advantageously Gold, Silver, Stainless Steel or Plastic, to support the watch for the user's chains or another hanging devices.

### DESCRIPTION OF DRAWING PART 2

FIG. 8 Shows a male connector element 10 slipping into the female strap 11 on an Apple® Watch. Decorative elements 12 may be inserted into the other female strap groove.

FIG. 9 Shows Gold, silver, Stainless Steel or Plastic chains s13+ attaching to the connector elements 10. Shows a male connector element 21 (Pocket Watch Flip Cover/front or Back) attaching to element 10 slipping into the female strap groove 11 on an Apple® Watch.

FIG. 10 Shows Gold, silver, Stainless Steel or Plastic CASE 22 Covering any Apple® Watch.

1. iJewelr® is claiming the rights of being able to turn the Apple®Watch into a form of Jewelry (Necklace or Pocket Watch) by adding accessories to it. We also are claiming the rights to being able to use the Apple®Watch as a form of ear peace for making phone calls in which the devise is hanging around the neck. iJewelr® is claiming the right Ia of being able to use the Apple®Watch as a form of PocketWatch. iJewelr® has a small pennant hanging from the bottom of the Apple®Watch in witch it gives it a jewelry type of look to the Apple®watch. iJewelr® is claiming the right to be able to take a male end of the. Apple®Watch that slide into the watch its self and combines it to a female end that is able to attach to a necklace or a PocketWatch. iJewelr® claims the right to be able to slide a decorative peace into the slop where a wrist band is usually placed. There is also a flip case that covers the back or front of the watch with a decorative Jewelry facing.
